(19) United States
(12) Patent Application Publication
(10) Pub. No.: US 2003/0049858 A1
(43) Pub. Date: Mar. 13, 2003

(54) Method and system for analyte determination in metal plating baths

(76) Inventors: Josh H. Golden, Santa Cruz, CA (US); Hugh E. Gotts, San Jose, CA (US); Jay Jung, Sunnyvale, CA (US); Marc Van Den Berg, Saratoga, CA (US)

Correspondence Address: DORSEY & WHITNEY LLP, Four Embarcadero Center, Suite 3400, San Francisco, CA, 94111-4187, US

(21) Appl. No.: 10/196,491

(22) Filed: Jul. 15, 2002

Related U.S. Application Data
(60) Provisional application No. 60/305,650, filed on Jul. 15, 2001.
(60) Provisional application No. 60/305,651, filed on Jul. 15, 2001.
(60) Provisional application No. 60/305,760, filed on Jul. 15, 2001.

(51) Int. Cl. G01N 21/62

(52) U.S. Cl. 436/171; 422/82.05

(57) ABSTRACT

The present invention relates generally to the field of metal plating. More specifically, the present invention is related to a method and system for determining the presence of analytes in metal plating solutions using Raman spectroscopy. In an additional embodiment a chemical auto-dosing system for controlling the concentration of one or more plating bath additives in a metal plating bath is provided.

### RELATED APPLICATIONS

This application claims priority to United States Provisional Applications Serial Number 60/305,650; 60/305,651; and 60/305,760, all filed on Jul. 15, 2001, the disclosures of which are hereby incorporated by reference in their entireties. This application is related to copending U.S. patent application Ser. No. ______:, entitled Method and System for The Determination of Arsenic in Aqueous Media (Attorney Docket No. A-70452/MSS/MDV), the disclosure of which is incorporated herein by reference.

### FIELD OF THE INVENTION

The present invention relates generally to the field of metal plating. More specifically, the present invention is related to a method and system for determining the presence of analytes in metal plating solutions using Raman spectroscopy.

### BACKGROUND OF THE INVENTION

Metal plating is used in a large variety of industrial processes. Plating systems, in which an object is placed in a plating solution to apply a metallic coating to the object, are well known in the art. Metal plating is used to plate a variety of metals, such as for example copper, zinc, nickel and gold. Many metals are plated simply by immersion in a metal plating bath, or electroplated when electrodes are placed in the bath. Copper plating has received significant interest due in part to its application to the semiconductor industry. Semiconductor fabrication includes the formation of different layers of material on substrates to form conductors and insulators to create integrated circuit patterns.

New generations of integrated circuits (ICs) increasingly are carrying electronic signals through copper wiring because metal wiring resistance and capacitance effects have become a limiting factors in microprocessor speed. This effect is generally referred to as RC delay. Because the transistor switching speed is no longer the limiting factor, a great deal of attention has focused on the successful integration of lower resistance copper wiring and low-dielectric constant materials to reduce RC delay. Copper wiring has approximately 40% lower resistance than conventional aluminum conductors and is deposited by the electrolytic filling of copper into trenches etched in a dielectric material. The copper wiring is connected to other wiring levels by a “via” of either tungsten or copper metal. The process of inlaying copper as both the wire and via in a dielectric trench is called the “dual damascene process.” The damascene process differs from that used to form aluminum lines in ICs because copper is difficult to uniformly sputter into trenches, it does not etch well, and it does not typically form volatile byproducts which can be removed during processing. For comparison, aluminum metallization is achieved by physical vapor deposition (PVD) or sputtering of aluminum metal onto the substrate, followed by masking and subtractive etching to form the lines of electronic conduction.

Two process steps must be applied prior to a copper inlaying step in a semiconductor processing system. First, a barrier layer of TaN, TiN, SiC, or the like, is deposited into the trench by PVD to prevent the diffusion of copper into the dielectric. Then, a uniform seed layer of copper is deposited onto the trench liner to serve as a substrate for copper nucleation and film formation. The copper seed layer is typically deposited using a directional ion beam. It is imperative that both the liner and copper seed layers are of uniform thickness and are chemically and physically homogeneous so that subsequent filling of the trench with copper metal is free of defects and voids. Production of homogeneous barrier and seed layers is expected to become even more challenging in the future as trench aspect ratios continue to increase to as high as 10:1 (0.1 μm wide×1.0 μm deep), and device dimensions and line widths shrink in accordance to Moore's Law.

After the deposition of barrier and seed layers, the inlay of copper may be achieved by electrolytic copper plating, in which the silicon wafer, or substrate, serves as the cathode. A sacrificial copper anode completes the circuit. The key to this process is filling of the trench from the bottom up. Otherwise, opposing sides of a deep vertical trench or via tend to grow together and “pinch off,” forming voids which negatively affect device integrity. A more detailed review of IC metallization and semiconductor processing may be found in H. Xiao, Introduction of Semiconductor Manufacturing Technology Prentice Hall, N.J., 2001.

Special inorganic and organic based additives are typically added to the acidic electrolytic copper sulfate solution to facilitate filling of the trenches with copper from the bottom up. Electrolytic plating additives are critical in the fill of high aspect ratio trenches and the production of defect free morphology. These additives typically include accelerators, brighteners, suppressors, and levelers, and are generally organic-based molecules or macromolecules. Chloride ions are also occasionally introduced to enhance adsorption of certain organic additives. Many of these additives and the bath formulations are proprietary formulations. However, in general, accelerators are small organic molecules containing sulfide or disulfide groups such as sulphopropyl sulfides or sulphopropyl disulfides.

In the manufacture of integrated circuits using copper damascene processing, small accelerator molecules migrate into the trench and increase the rate of copper deposition in the trench from the bottom of the trench upward. Accelerators are chemically active molecules that coordinate with copper ions to mediate the transfer of electrons. Accelerator molecules are directly consumed during the plating process and decompose to a variety of byproducts. Brighteners are typically small molecules such as formaldehyde, or in some cases, sulfides or disulfides that affect the grain size of the plated copper. Grain size is important with regards to annealing and crystal structure which ultimately affects conductivity. Coarse grain sizes tend to diffract light, while smaller grain sizes are more reflective (thus the origin of the name brightener). Suppressors are usually low molecular weight macromolecules, such as, for example polyethers, with molecular weights in the approximate range of 2000 to 5000 grams per mole. They are used as grain size refinement aids or as mediators to regulate the reactivity of accelerators near the top of trenches that are being filled. This suppressing action, which typically occurs by surface adsorption, prevents metal from rapidly spilling over the side of a filled trench or overflowing out of the trench. Due to size constraints, suppressor macromolecules cannot get into the very small trench, but rather are thought to migrate and collect at the top comers of the trench or at the surface. Suppressor molecules are also consumed during the plating process via decomposition or chain cleavage. Chloride ions are typically introduced to aid the adsorption of the suppressor. Levelers are used to passivate the top surface on the outside of the trench in a dual damascene copper plating process for IC interconnects. Levelers are usually macromolecules, with molecular weights that may approach approximately 1 million or more grams per mole. Similarly to suppressors, levelers mediate the rate of metal deposition by blocking accelerators outside of a trench. However, levelers are active well outside of the trench due to molecular size constraints. Levelers ultimately make the surface more level and smooth, which improves the efficiency of post-processing steps, such as for example chemical-mechanical polishing. Levelers are typically more resistant to decomposition and chain cleavage than suppressors. Some manufacturers interchangeably use the terms accelerator, brightener, suppressor, and leveler which may cause confusion, depending on the manufacturer, the application, and the plating formulation. For the purposes of the present invention, the above simplified summary and description will suffice. More detailed information on bath formulations and their behaviors can be found in the following U.S. Pat. Nos.: 4,347,108; 4,490,220; 4,786,746; 4,897,165; 5,252,196; and 5,730,854.

Despite its popularity, electroplating has drawbacks. Electroplating is a wet processing technique that is very sensitive to process variations. In prior applications of electroplating the process has been rather loosely controlled. These prior techniques are not well suited to semiconductor fabrication which requires tightly controlled and high quality, reproducible processes. Another significant drawback of electroplating processes is maintaining the chemical purity of the plating bath and the desired composition and concentration of the various additives in the plating bath. This problem is of even greater concern when the metal plating process is used to plate metal on semiconductors. When plating bulk copper to form copper interconnects for example, the copper plating solution must be capable of producing a copper layer of high quality without impurities. Accordingly, there is a significant need for a method and system for accurately and quickly determining the presence of chemical species such as plating bath additives in metal plating solutions, and further the composition and/or concentration, and thus the purity, of such plating solutions.

Organic plating additives are typically very dilute in metal plating solutions. For example, the concentration of the organic additives in an electrolytic copper sulfate plating solution can be in a range from less than 100 ppm or even lower than 1 ppm, depending on the formulation. In contrast, copper sulfate plating solutions typically contain many tens of grams per liter of copper and sulfate, usually in massive excess. As the plating process progresses, accelerator, suppressor, and leveler additives are consumed to varying degrees and must be replenished. In prior art systems, replenishment is typically achieved either by complete dumping of the bath or by a bleed and feed protocol in which fresh additive solutions and/or a complete replacement bath is slowly fed into the active bath while the old bath solution is drained away as in a continuous flow stirred tank reactor (CFSTR). This is an expensive and wasteful method of ensuring that the additive concentrations remain within optimal parameters.

Electroless plating is an alternative metal plating technique that has recently gained momentum in the fabrication of interconnect structures. Electroless plating involves the use of an in situ chemical reducing agent such as hypophosphite, dimethylamine borane, borohydride, formaldehyde and the like to reduce metals in solution. Electroless plating has certain advantages over electrolytic plating. For one, electroless plating deposits conformal metal coatings in high aspect ratio trenches. A variety of metals and metal alloys can be deposited directly from solution in this fashion. Electroless plating is especially effective for the deposition of barrier films such as cobalt tungsten phospate (CoWP) and cobalt tungsten borate (CoWB) in high aspect ratio trenches, the deposition of copper seed, as well as copper fill. Electroless chemistries are expected to replace PVD barrier and seed and electrolytic plating deposition methods in IC manufacturing within the next five to eight years.

Because of the potential displacement of electrolytic plating techniques by electroless techniques, there is a need for an analytical technique for monitoring the constituents of an electroless plating bath over time. As in electrolytic plating systems, the composition of the various additives in an electroless bath must be tightly controlled to deposit high quality, defect-free films and layers. Currently, liquid chromatography (LC) is used to monitor these baths. LC requires manual injection of a sample in a column and a delay while the chemical species elute over time. The chemical species may be identified spectrophotometrically or on the basis of elution time when compared to known controls. This process takes typically 30 minutes or more, so it is not considered real-time monitoring. Moreover, because the additives in an electroless bath are present at very high concentrations, often on the order of grams per liter, LC analysis also requires that that the samples be diluted prior to injection, which introduces an additional labor intensive step to the process. Thus, there is a need for a real-time, in situ, quantitative method for analysis of electroless plating bath additives. Additional information on electroless deposition in IC manufacturing can be found in G. Malloy and J. Hajdu, Electroless Plating Fundamentals and Applications, Reprint Edition, Noyes, N.Y., 1990 as well as in to U.S. Pat. Nos. 5,695,810, 6,323,128, and 6,287,968, and Lopatin, et. al., in Characterization of Cu, Co, Ni and Their Alloys for ULSI Metallization, Conference Proceedings ULSI XIII, Materials Research Society, 1998.

Cyclic voltammetric stripping (CVS), or impedance measurements, have been used to monitor electrolytic plating bath performance by measuring the rate of metal plating, which is highly dependent on the additive concentration. With the CVS technique, the potential of the inert electrode is cycled at a constant rate in the bath, so that a small amount of metal is alternately plated-and removed (stripping). The area under the stripping peak is proportional to the plating rate and thus the concentration of the additives and their ratio to one another. It is easy to see that this technique is an indirect measurement of additive concentration, and thus solely depends on the ratios and concentrations of these components, as well as their synergistic interactions (both positive and negative). The CVS method is thus highly empirical and demands significant input from a highly skilled and experienced operator. Moreover, CVS and related methods may require handling of bath chemistry for analysis in a chemistry lab and generate a waste stream that requires special handling and disposal. Finally, CVS requires approximately 30 minutes or more to perform before a bath is qualified for use. Nonetheless, due to a lack of alternatives, metal plating industries and semiconductor plating operations have adapted CVS and related methods for electrolytic plating bath analysis and process control despite its limitations and expense. Moreover, CVS is not applicable to analysis of electroless plating bath additives.

Because of the limitations of CVS and other available analytical methods for quantifying concentrations of metal plating bath additives, an improved analytical technique for measuring bath performance in relation to the additive concentration is highly desirable. Ideally, such a method would insure that the proper concentration of these materials are maintained, and that the process is stable. Spectroscopic methods are direct with results obtained in real-time and thus can be used for real-time process control with minimal lag time. A direct in situ spectroscopic method is preferable to an indirect method such as titration, LC, CVS or similar electrochemical analyses. However, because metal plating baths use water as a solvent and contain dissolved metal ions and/or complexes, typical spectroscopic absorption techniques are of little to no utility. For example, UV-visible and infrared (IR) spectroscopic techniques have severe limitations in detecting dilute additives in metal plating solutions because metal plating solutions are highly absorbing in the IR and UV-visible range. As illustrated in FIG. 1 which shows an absorbance spectrum, a typical copper electroplating solution has significant absorption bands in the wavelength range of approximately 200 nm to 340 nm, and also in the range of approximately 550 nm to 800 nm and higher. Although there is a small window between approximately 340 nm and 600 nm in which no interfering bath absorption occurs, many plating bath additives do not absorb or fluoresce in this range. Infrared spectroscopy is not a useful technique because water has a very strong —OH vibrational band at about 3500 cm⁻¹ that obscures most useful chemical information.

Raman spectroscopy is a spectroscopic technique that operates on the principle that light of a single wavelength striking a molecule is scattered by the molecule through a molecular vibration state transition. The resultant scattered light has wavelengths different than the incident or excitation light. The wavelengths present in the scattered light are characteristic of the structure of the molecule. The intensity and wavelength or “Raman Shift” of the scattered light is representative of the concentration of the molecules in the sample. Raman spectroscopic analysis interrogates polarizability changes in the molecule to determine the presence or absence of molecular bonding, and by inference, the chemical species. Approximately 1 part in 1 million of the incident light is scattered. When a photon of incident light interacts with a molecule, in most cases, this interaction leads to the molecule assuming a more excited (higher energy) vibrational state with the emission of a photon at a longer (less energetic) wavelength. Because a small fraction of molecules in any sample already exist in an excited vibrational state, some interactions between an incident photon and a molecule may lead to a decrease in the molecule's vibrational energy state with a concomitant emission of a photon at a shorter (more energetic) wavelength. These Raman effects, including resonance Raman spectroscopy (RRS), surface enhanced Raman spectroscopy (SERS) and surface enhanced resonance Raman spectroscopy (SERRS) are generally described in greater detail in Grasselli et al., Chemical Applications of Raman Spectroscopy, Wiley-Interscience, John Wiley and Sons, New York, 1981. In addition, a variety of Raman spectroscopy devices have been developed in the industry. For example, a fiber optic type device is described in Angle, S. M., Vess T. M., Myrick, M. L., Simultaneous multipoint fiber optic Raman sampling for chemical process control using diode lasers and a CCD detector, SPIE vol. 1587, p. 219-231, Chemical, Biochemical, and Environmental Fiber Sensors III, 1992.

Many important molecular functional groups are inactive or weak in absorption processes, but show significant activity in Raman spectroscopy. These functional groups include, but are not limited to, carbon-carbon bonds; metal oxygen bonds (metal-oxo-anions); and main group oxyanions such as sulfate, phosphate, and nitrate. A preferred Raman sensitive functionality has the proper symmetry of chemical bonds so that a strong Raman response is obtained. Raman responses are typically characterized as being in the range from weak (lowest sensitivity) to very strong (highest sensitivity). For example, the Raman sensitive functionality may comprise a chemical group, such as for example a nitrile or a quaternerized amine, that has a strong scattering response in a wavelength range where water scattering does not occur. Other Raman sensitive groups may include, among others, carbonyls, ketones, hydrazones, saturated and unsaturated carbon, alcohols, organic acids, azo, cyanates, sulfides, sulfones, and sulfonyls. A great variety of organic and inorganic compounds yield useful Raman signals. A large variety of transition metal oxo-anions and complexes, as well as ions selected from the main-group elements also have a good Raman scattering response. Examples include, but are not limited to, tungstate, sulfate, nitrate, phosphate, and borate.

While Raman spectroscopy has been described, in current applications it suffers from many difficulties that limit its usefulness in commercial applications. One significant problem with Raman spectroscopy is the low intensity of the scattered light compared to the incident light. Isolating, amplifying and processing the scattered light signal typically requires elaborate and costly equipment. A further problem is interference with the Raman signal due to fluorescence, or emission of light due to electronic state transitions, from a solution or composition under analysis. Many compounds fluoresce or emit light when exposed to laser light in the visible region. Fluorescence bands are generally broad and featureless, and the Raman signal can often obscured by the fluorescence. Again, complicated and costly sensors and signal processing equipment are needed to process the signal.

Additional problems with Raman spectroscopy include overlapping peaks of multiple compounds in a sample being analyzed and solution self-absorption. When a variety of compounds are present in a sample to be analyzed, all of the compounds contribute to the Raman signal. Determining and quantifying chemical analytes in metal plating solutions on a real time basis in an industrial setting requires a method and system capable of identifying the analytes despite spectral interference from one or more other compounds present in the plating bath. In solutions with strong absorbance at or near the wavelength of the incident light, the strength of the resultant Raman signal is decreased due to absorption of both the incident light and Raman scattered light by the solvent and solution components. Attenuation of the incident light degrades the intensity of the Raman interactions of irradiated molecules by decreasing the incident photon flux while absorption of the scattered light increases the difficulty of extracting useful species identification and quantification information from the background spectral noise. Thus, further developments in Raman spectroscopy systems and methods are needed.

### SUMMARY OF THE INVENTION

Accordingly, it is an object of the present invention to provide a method and system for identifying the presence of analytes in metal plating solutions. More specifically, the present invention provides a method and system for determining the presence and/or concentration of analytes in metal plating solutions using Raman spectroscopy. The present invention also provides a system and method of controlling via a feedback loop the automatic autodosing of chemical reagents into a plating bath as needed to maintain optimal process concentrations and parameters.

In one embodiment of the present invention, a Raman spectroscopy system for quantifying concentrations of one or more metal plating bath additives in a metal plating bath is provided. The system includes a monochromatic light source that provides incident monochromatic light at a wavelength chosen to fall within a region of low light absorbance on the ultraviolet-visible light absorbance spectrum for the bath solution. A detector for detecting a bath emission spectrum of Raman scattered light from the bath is also provided. Incident monochromatic light is conducted to the sample via a probe assembly that comprises an immersible head. The immersible head includes a probe window that is transparent to the chosen incident monochromatic wavelength as well as to wavelengths at which Raman emissions are expected. In operation, the immersible head is immersed in a subvolume of the bath such that the probe window is completely submerged to exclude ambient light. A first fiber optic cable transmits the incident monochromatic light from the source to the immersible head from which it is directed into the sample subvolume through the probe window to produce a bath emission spectrum of Raman scattered light with peaks at one or more scattered wavelengths. A second fiber optic cable transmits Raman scattered light that passes into the immersible head through the probe window from the immersible head to the detector. Each of the bath emission spectrum peaks has an associated area and a height. These areas are input into a spectrum processor that calculates the concentrations of each of the metal plating bath additives using a linear algebra-based method to deconvolute the peaks in the bath emission spectrum of Raman scattered light based on pre-calculated ratios of the areas under a plurality of peaks in a standard emission spectrum for each of the metal plating bath additives.

In a further embodiment of the present invention, a method is provided for quantifying concentrations of one or more metal plating bath additives in a metal plating bath. A standard emission spectrum is collected for each of the metal plating bath additives individually. Based on these standard spectra, a ratio of peak areas or heights between each of the resultant peaks in each spectrum is calculated. Incident monochromatic light at a chosen wavelength is transmitted from a monochromatic light source to a sample of the bath. The wavelength of the monochromatic light is selected to fall within a region of low light absorbance on an ultraviolet-visible light spectrum collected for the bath. The incident monochromatic light from the source is conducted via a first fiber optic cable to an immersible probe submerged in the bath sample. The focal point of the incident laser light is adjusted such that its penetration depth into the sample is in the range of approximately 0.1 mm to 1 cm. Light emitted by Raman scattering in the sample subvolume is received by the immersible head and transmitted to a light detector via a second fiber optic cable which detects the emitted light and converts it into a bath emission spectrum. The resultant bath emission spectrum is analyzed to quantify the concentrations of metal plating bath additives in the subvolume by creating a series of coupled linear equations in which the concentrations of the metal plating bath additives are unknowns and the pre-calculated peak area or height ratios are knowns. The set of linear equations is solved using linear algebra or other applicable methods of analysis.

In another embodiment of the present invention, a chemical auto-dosing system for controlling the concentration of one or more plating bath additives in a metal plating bath is provide comprising: a Raman spectroscopy probe that interfaces with said plating bath; one or more additive reservoirs each containing one of said one or more plating bath additives; and one or more metering pumps that control the flow of said plating bath additives from said reservoirs to said plating bath. A Raman spectrometer is coupled to said Raman probe for quantifying a Raman spectrum emitted from said plating bath and collected by said probe. An analyzer subsystem controller that processes said Raman spectrum to determine real time concentrations of said plating bath additives in said plating bath is provided; and a processing subsystem controller that receives and processes concentration data from said analyzer subsystem controller to provide control outputs to said metering pumps.

### BRIEF DESCRIPTION OF THE DRAWINGS

Other objects and advantages of the present invention will become apparent upon reading the detailed description of the invention and the appended claims provided below, and upon reference to the drawings, in which:

FIG. 1 is a chart showing a sample absorbance spectrum for light wavelengths between 200 and 1400 nm for a representative metal plating bath.

FIG. 2 is a schematic diagram illustrating the Raman device of another embodiment of the present invention.

FIG. 3 is a schematic diagram showing a more detailed view of a sampling probe according to one embodiment of the present invention.

FIG. 4 is a schematic diagram showing a more detailed view of a flow cell according to one embodiment of the present invention.

FIG. 5 is a schematic diagram showing a detail of a probe head with a ball lens according to one embodiment of the present invention.

FIG. 6 is a schematic diagram showing a detail of a probe head with an adjustable focal length lens according to one embodiment of the present invention.

FIG. 7 is a graph showing an example of a Raman calibration curve of peak area vs. concentration for an additive in an electrolytic metal plating bath.

FIG. 8 is an example of a representative Raman spectrum for a solution containing a polyethylene glycol suppressor.

FIG. 9 is a flow chart showing the steps by which a spectrum of overlapping peaks is deconvoluted to calculate concentrations of multiple analytes.

FIG. 10 is a schematic diagram showing an integrated plating bath analyzer system according to one embodiment of the present invention.

FIG. 11 is an example of a representative Raman spectrum for an electroless copper plating bath.

FIG. 12 is a graph showing an example of a Raman calibration curve of peak area vs. concentration for a reducing agent additive in an electroless metal plating bath.

FIG. 13 is a graph illustrating the detection of a suppressor additive at a concentration of 8 ppm in an electrolytic plating make up solution in accordance with one embodiment of the method and system of the present invention.

FIG. 14 is a graph illustrating the detection of an accelerator additive at a concentration of 2 ppm in an electrolytic plating make up solution in accordance with one embodiment of the method and system of the present invention.

FIG. 15 is a chart showing a spectrum obtained from analysis of a plating bath solution as detailed in experimental example 2.

### DETAILED DESCRIPTION OF THE INVENTION

The present invention provides a method and system for identifying chemical analytes in metal plating solutions. More specifically, the present invention provides a method and system for determining the presence and/or concentration of inorganic and organic additives in metal plating solutions using Raman spectroscopy.

The present invention provides a rapid and real-time method and system of quantifying organic and inorganic additives and other species in metal plating solutions and, in a further embodiment, of automatically replenishing the concentrations of additives of interest in response to the measurements. Concentrations of these species may be in the ppm (part per million) range in electrolytic baths or in the grams per liter range in electroless baths. More specifically, the present invention provides a methodology and system for the quantification of inorganic or organic chemicals in plating baths over a broad concentration range. The present invention provides a method for detection and quantification that employs Raman spectroscopy in conjunction with inventive techniques that diminish or eliminate photon absorbance characteristics of the aqueous system that can interfere with accurate detection of analytes of interest. The Raman spectroscopy system and method of the present invention provides rapid and quantitative measurement of relatively dilute organic and inorganic species which are extremely difficult to quantify in real time using prior art methods.

First discovered by C. V. Raman in 1928 (Nature (London), v. 121, p. 501 (1928)), Raman spectroscopy has great potential as a novel and efficient method for real-time quantitative metal plating bath analysis. In general, Raman spectroscopy involves the scattering of incident light by molecules. While most of the incident radiation is scattered elastically, a small fraction of photons return with higher or lower energy, usually 1 in 1 million or so. A net loss of photon energy (increase in wavelength) results from the photon's induction of a molecular vibration in a molecule it encounters. In contrast, a gain in energy (decrease in wavelength) by the photon is a result of the absorption of a molecular vibration by the photon interacting with a previously excited molecule that drops to a less energetic vibrational state as a result of the interaction. Formally, the photon interactions are a result of a change of molecular bond polarizability (P) due to the interaction with a photon's electric field (E), as expressed in equation 1:

P=aE (1)

The Raman effect increases in strength at shorter incident light wavelengths Observed Raman peaks are typically shifted to lower energies than the incident radiation (Stokes shift). This is due to the higher probability of a change in polarizability, or vibrational transition at room temperature, because most of the molecules are at a lower energy vibrational state. However, the photon can interact with a small fraction of high energy vibrational states that are also populated, resulting in emission of a higher energy photon (anti-Stokes shifted). Raman response is also dependent on laser wavelength. Signal intensity I, is dependent on wavelength (λ), as expressed in equation 2:

I≈λ⁻⁴ (2)

According to equation 2, a 532 nm laser yields approximately 5 times greater Raman response intensity than a 785 nm laser. Therefore, the inventors have discovered that it is advantageous to chose a higher energy laser to promote greater signal to noise ratio and shorter spectrum acquisition times. However, the higher energy of lower wavelength photons can also induce fluorescence emissions which may mask the Raman response in some samples. According to the present invention, a further consideration in Raman spectroscopy is taught that, though the intensity of Raman signal is linearly dependent on the power of the incident light and it may in some cases be advantageous to employ a higher powered light source, sheer brute force application of additional incident radiation power may not be advantageous due to the potential for inducing undesirable physical and chemical changes in the sampled bath under high power density conditions.

Raman spectroscopy has significant advantages over absorption techniques such as UV-visible, near infrared and mid infrared, especially in aqueous plating bath analysis. Water is a weak Raman scatterer in the range of approximately 300 to 800 nm. However, non-Raman spectroscopic techniques may be overwhelmed by absorption of incident photons by dissolved ions or water itself due to its presence in overwhelming excess. An effective normalized range for Raman signals in wavenumbers is typically from 200 cm⁻¹ to 3000 cm⁻¹, which allows for the detection of a large variety of inorganic and organic species in aqueous media.

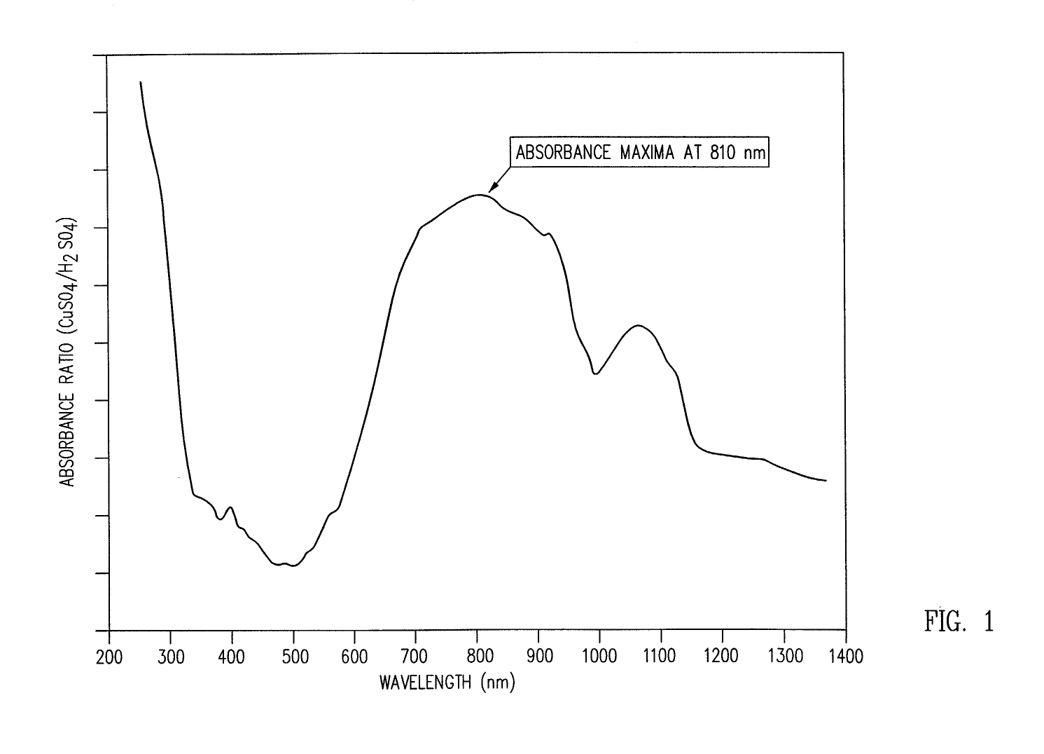

A metal plating bath containing aqueous copper sulfate may be first analyzed by UV-visible spectroscopy. As shown in FIG. 1 and discussed above, the solution is highly absorbing (high extinction coefficient), except in the wavelength range of approximately 300 to 680 nm. Absorbance is described by Beer's law:

A=εBC (3)

Where A is absorbance, ε is the extinction coefficient, B is the path length, and C is the concentration. Identifying the window of relatively high transmission in the absorption spectrum of an electrolytic plating bath allows a choice of incident laser light, preferably a diode laser source, that transmits light with a wavelength in the range of approximately 300 to 680 nm. If a laser is chosen that transmits radiation at or near the absorption maxima of the solution, the Raman effect is greatly diminished as photons that would otherwise be available to stimulate Raman emissions from the molecules of interest are attenuated by absorbance within the bulk fluid. Moreover, substantial solution absorption at the laser wavelength results in an exponential relationship between intensity and concentration, which is a significant source of error in quantitative detection of the analyte or analytes of interest. Therefore, it is important to choose the correct laser incident wavelength. In this embodiment of the present invention, an 84 mW green Nd:YAG laser source that transmits at 532 nm is used. The power of the laser is not limited, however, a range of 5 to 200 mW is preferred for best signal generation. A 532 nm diode laser source is preferred for the analysis of copper sulfate solutions because it emits within the window of solution light transmission and is compact and efficient. Those skilled in the art can select the correct wavelength of incident monochromatic light for other applications based on the teaching of the present invention.

In this embodiment of the present invention, a method and system for sensing analytes in metal plating solutions is provided wherein a Raman spectroscopy sensor is utilized. While the exemplary embodiment described herein shows an electrolytic copper metal plating solution, the present invention may be used for a variety of metal plating solutions including electroless plating solutions. The Raman sensor generally includes a monochromatic light source to probe a metal plating solution containing one or more analytes. Generally, the plating solution is passed through a fluid path which intersects the light source. The monochromatic light source may be a diode laser, gas laser, filtered high intensity light source and the like. As the monochromatic light source probes the plating solution, light is scattered. Individual wavelengths of the scattered light are separated using a compact monochromator in either a static or scanning mode, with detection provided by a detector such as a high sensitivity CCD or diode array detector. Additionally, source photons may be carried to the solution utilizing a series of bundled fibers which return the light to the detector for subsequent evaluation.

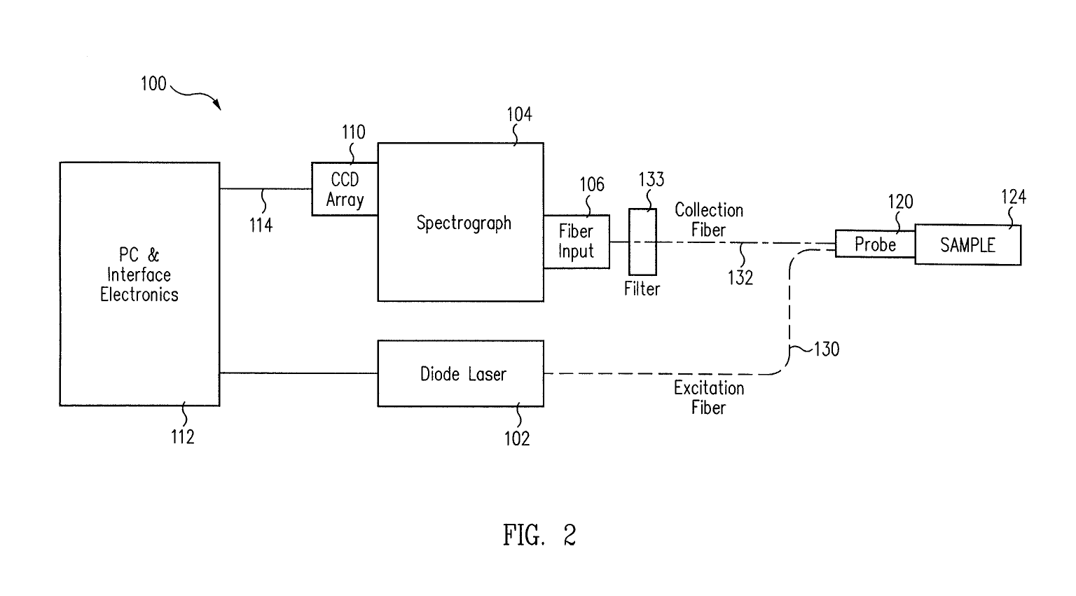

A Raman spectroscopy sensor 100, particularly suitable for detection of analytes in metal plating solutions, in accordance with this embodiment of the present invention is illustrated in FIG. 2. The sensor 100 generally includes a monochromatic light source 102, a spectrograph 104, a probe 120 that is coupled to the light source and spectrograph through an excitation fiber 130 and a collection fiber 132 respectively, for delivering incident light to and collecting scattered light from a sample 124, a fiber input 106 and CCD array 110 coupled to the spectrograph 104, and a personal computer data processor with interface electronics 112 for controlling the system and processing the output from the spectrograph 104.

In the exemplary embodiment shown in FIG. 2, the monochromatic light source 102 is preferably comprised of a frequency doubled YAG diode laser, operating at 20 mW, 0.1 nM stability with 1.5 mrad beam divergence. The diode laser is powered by a power supply (not shown) which preferably is 120 V temperature stabilized. In one embodiment, the excitation light from the diode laser is focused onto a fiber end of the excitation fiber 130 which conducts the incident light to the probe 120 for focusing into a sample subvolume 124. Preferably both the excitation fiber 130 and the collection fiber 132 are comprised of a poly-micro fiber optic cladded light guide.

A plating solution sample 124 to be analyzed enters the sample subvolume either through normal operating circulation of the bulk bath or via one or more pumps (not shown). The bath interacts with the excitation light delivered by the excitation fiber 130 to the probe 120 to yield Raman scattered light. Light scattered from the solution—the Raman radiation or signal—is collected by the probe 120 and delivered to the fiber input 106 via the collection fiber 132. From the fiber input 106, collected scattered light passes into the spectrograph 104 wherein it is analyzed to yield a spectrum which is quantified in real time via a CCD array 110.

The Raman signal preferably passes through a filter 133 which is preferably a reject filter chosen to filter out light at the incident wavelength to prevent swamping of the CCD detector, and is coupled via a SMA connection to fiber optic borosilicate glass, prior to analysis in the spectrograph. Borosilicate fiber has a Raman shift of a well defined wavelength notch for baseline frequency calibration. Various spectrographs 104 may be used. In one embodiment, the spectrograph is a CS400 Micropac with Hamamatsu 256Q cooled array. A serial interface 114 may be provided for coupling the processed signal to a computer system and interface electronics 112 for display and/or analysis.

The spectrometer is optical and mechanical in nature. The Raman scattered light delivered via the collection fiber 132 from the sample is projected onto the CCD array 110. A charge-coupled device (CCD) is a light sensitive integrated circuit that quantifies the intensity of the light by converting the light into an electrical charge. The CCD data or spectrum is then analyzed to calculate the concentration levels of additives and byproducts. The computer system 112 preferably consists of a computer, a CCD controller card that plugs into the computer mother board, communication PC cards such as a modem and an Ethernet card among others, and digital and analog input/output ports.

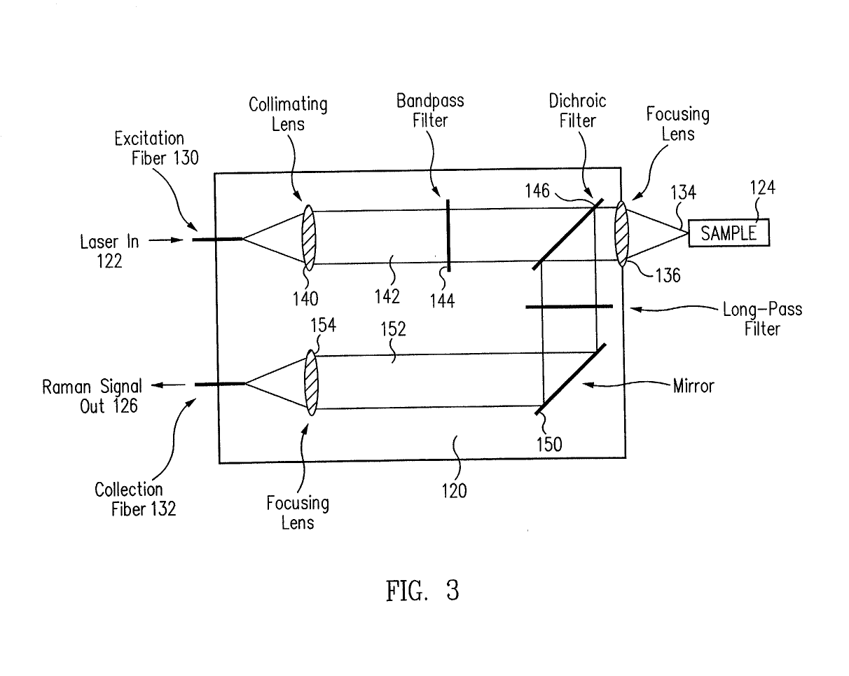

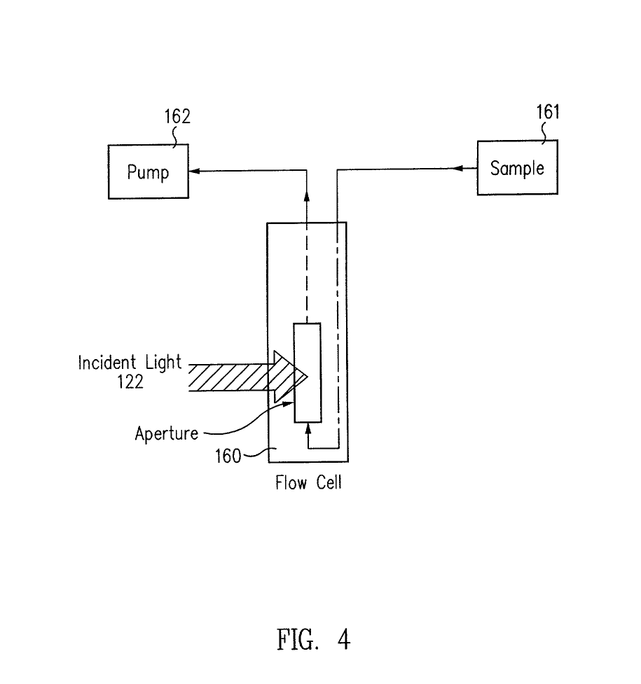

FIGS. 3 and 4 are schematic diagrams providing additional detail of an exemplary system according to one embodiment of the current invention. An immersible probe 120 that transmits the incident light 122 from a diode laser light source 102 to the analyte solution sample 124 and also receives the scattered signal 126 is used in this embodiment. Incident light 122 is transmitted from the monochromatic light source 102 to the probe via an excitation fiber optic cable 130. Scattered light is collected by the probe and transmitted to a fiber input 106 to a spectrograph 104 by a collection fiber optic cable 132. The focal point, or working distance 134 of the laser light 122 is adjusted so that its penetration depth into the solution sample 124 is preferably in the range of approximately 0.1 mm to 1 cm, with a range of approximately 0.1 to 5 mm most preferred. The working distance 134 is adjusted according to the turbidity of the solution as well as its self-absorption characteristics. The probe 120 is constructed of materials that resist the corrosive effects of an acidic aqueous environment such as, for example Monel alloy, Teflon, or other inert materials. A probe window or more preferably a lens 136 is provided through which incident and scattered light pass out of and into, respectively, the probe. This window or lens 136 is preferably constructed of either sapphire or quartz. The probe 120 is immersed into the plating bath or some other subvolume containing a sample such that ambient light is excluded. It is preferred that the probe 120 is immersed in a subvolume or region of the plating bath or test solution in which circulation past the probe is sufficient for continuous monitoring of a dynamic chemical environment that is representative of the bath as a whole. The probe 120 may be preferably placed in a pipe or some other custom built chamber with appropriate pumps to circulate the solution past the probe and prevent interference from ambient light.

FIG. 3 also shows additional details regarding a preferred embodiment of the probe. In a preferred embodiment of the present invention, an 84 mW green Nd:YAG laser source is provided that transmits at 532 nm in conjunction with a short path length quartz flow cell to reduce the absorbing characteristics of the solution. The sample 124 is housed in a pipe or chamber (not shown) that interfaces with the probe 120. In this embodiment, light conducted to the probe by the first or excitation fiber optic fiber 130 enters the chamber and passes through a collimating lens 140 which collimates the light. The collimated light beam 142 then passes through a bandpass filter 144 and a dichroic filter 146 before exiting the probe via a focusing lens 136 that focuses the light beam 142 on the sample 124 at the desired working distance 134. Light scattered from the sample 120 passes back through the focusing lens 136 into the probe 120 where the dichroic filter 146 diverts light that differs from the incident beam wavelength at a 90° angle to a mirror 150 angled at 45° to redirect the scattered light beam 152 parallel to the incident collimated beam 142. The scattered light passes through a second focusing lens 154 that focuses it into the second, collection fiber optic fiber 132 for transmittal to the detector.

Because absorbency is proportional to path length, the path length is chosen to minimize absorbance of the incident laser by the solution under analysis. A path-length that is too long may result in the capture of both incident laser light and the emitted Raman signal by the inherent absorbancy of the sample. A flow cell with a fixed path length as shown in FIG. 4 may preferably be used for continuous monitoring of the dynamic plating bath environment. Sample solution 161 is circulated through the flow cell 160 via pressure or aspiration by mechanical and/or micromechanical pumps 162. The flow cell path length may preferably be in the range of approximately 0.1 to 10 mm. More preferably, the flow cell path length through which incident light from the probe passes is in the range of approximately 0.1 to 1 mm. The cell preferably interfaces with a fiber optic probe of the same general design as shown in FIG. 3.

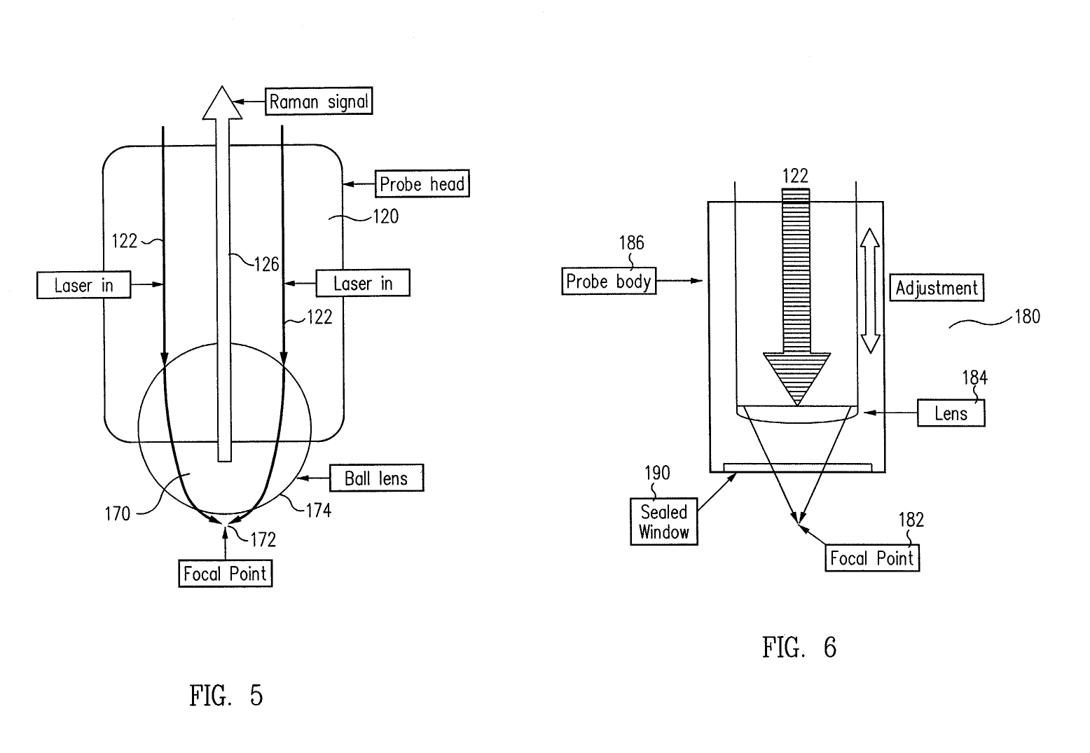

In another embodiment of the present invention, an immersible probe as shown in FIG. 3 is provided that includes a ball lens. Use of a ball lens provides the following advantages: the focal distance is always tangent to the ball lens surface and thus constant thereby providing a constant sample volume, the probe is always properly aligned when it is in contact with a sample, and there are no moving parts. A general schematic of an exemplary ball probe according to this embodiment is shown in FIG. 5 which includes a ball lens 170 having a focal point 172 on its surface 174. The ball lens 170 is mounted in a probe head 120 that includes appropriate optics (not shown) to convey an excitation beam of monochromatic light 122 to the ball lens 170 and a beam of scattered light 126 away from the ball lens and to an appropriate detector or detectors. In general, the ball lens 170 is housed in a barrel-shaped probe that is preferably constructed of materials such as for instance Monel alloy, Teflon, or other inert, acid resistant materials. The ball lens is preferably constructed of sapphire or quartz or other materials that are both acid resistant and transparent to the incident and scattered light wavelengths. Because the ball lens probe has its focus at the surface of the sphere, constant sampling precision and repeatability is enhanced. It is preferable to position the probe in contact with the bath such that ambient light is excluded and where circulation of the bath past the probe is sufficient to allow for continuous monitoring of the dynamic chemical environment within the bulk of the bath. The probe is thus preferably placed in a pipe or chamber or other customized subvolume equipped with appropriate pumps to circulate a sample of the bath past the ball lens and exclude ambient light.

In a preferred embodiment of the present invention, an immersible probe 180 as illustrated in FIG. 6 is provided. The probe 180 includes an adjustable focal point 182 for incident light 122 provided by an excitation fiber 130 from a monochromatic light source 102 as shown in FIG. 2. The focal point 182 of the incident laser light is adjusted by moving an adjustable lens 184 within the probe body 186. The focal point 182 is adjusted such that it is within the sample subvolume immediately outside of a sealed probe window 190 through which the focused beam is projected. The close proximity of the beam focal point to the window—it is preferably in the range of approximately 0.1 to 5 mm from the outer surface of the window 190—mitigates potentially confounding effects of solution absorption and light scattering by particles on the collected Raman spectrum and subsequent analytical steps.

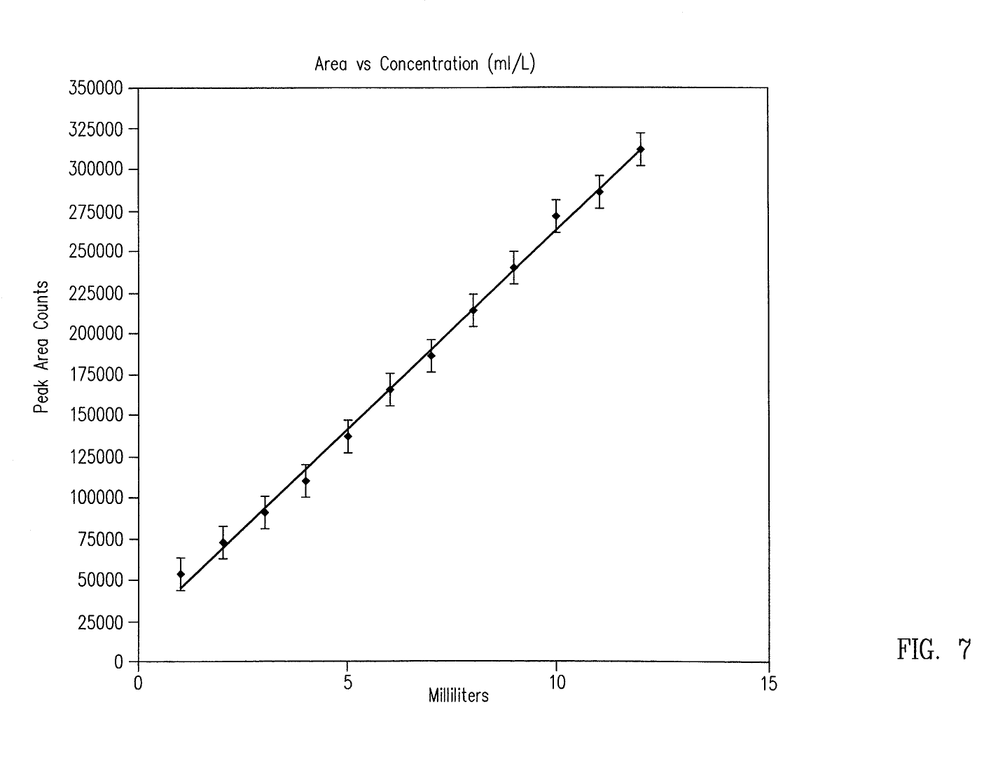

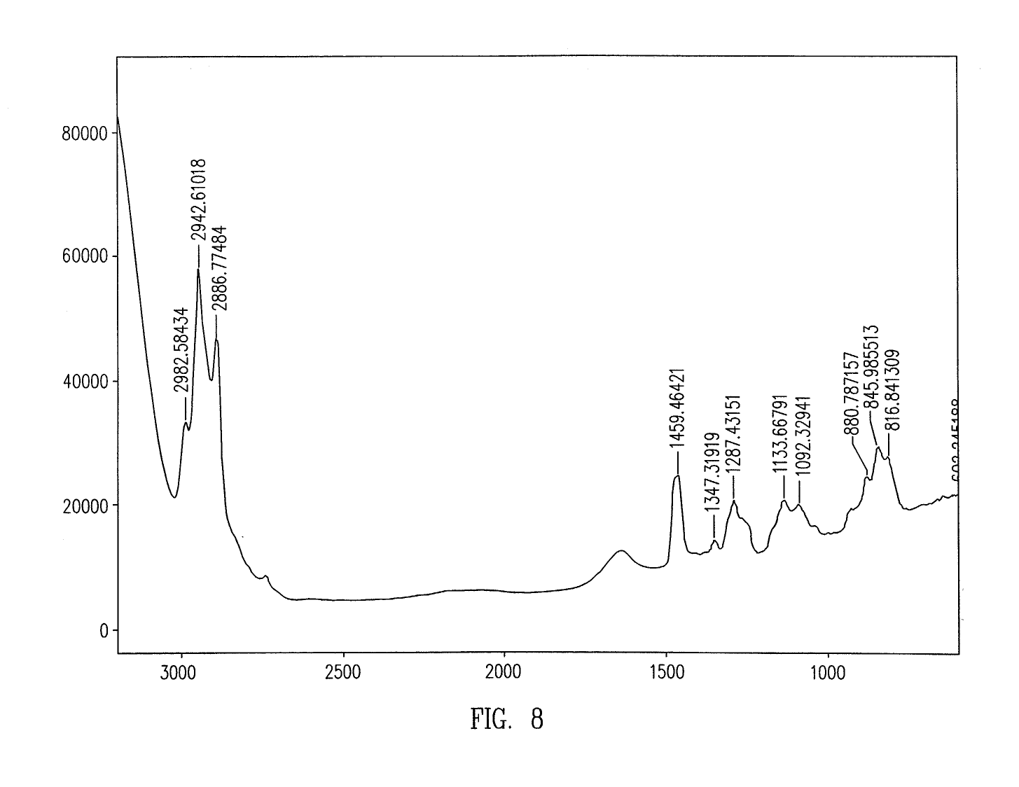

Spectral data collected via the aforementioned embodiments are preferably analyzed for features that can be ascribed to certain chemical species. The Raman shift of individual chemical species is preferably identified prior to analysis by separate measurement of individual components. Quantification of the individual components in a plating bath mixture is preferably achieved by determination of the peak area and/or height of the chemical species of interest, followed by comparison of these data to a straight-line calibration curve. The linear calibration curve is preferably generated by plotting peak area and/or height versus concentration of samples in which the concentration of the analyte of interest is known. Standard methods of statistical analysis including, but not limited to, linear regression may be applied to obtain a best fit straight line calibration curve. FIG. 7 shows an exemplary calibration curve generated by Raman analysis of known samples of a polyether suppressor macromolecular additive typically used in electrolytic plating baths. The best fit calibration line was determined by linear regression. FIG. 8 shows an exemplary Raman spectrum of a solution containing a polyethylene glycol suppressor additive. The spectrum reveals variety of alkyl group signatures which are useful for quantitative analysis.

Commercially available software packages for spectral analysis may be used in conjunction with the above described system and method. These include Unscrambler by CAMO Technologies, Woodbridge, N.J. which is used to create calibration curves and goodness of fit metrics and to perform integration of peak areas and quantification of peak height. In addition, the software includes routines that eliminate extraneous effects that could have a negative impact on the area or peak height measurement, such as, for instance, fluorescence. Spectral software package for qualitative and quantitative analysis that include quantification of peak area and height are Unscrambler by CAMO and the GRAMS/AI package provided by Thermo Galactic, Salem, N.H. PLSplus/IQ, also provided by Thermo Galactic is used to perform partial least squares analyses on spectral data as is Unscrambler.

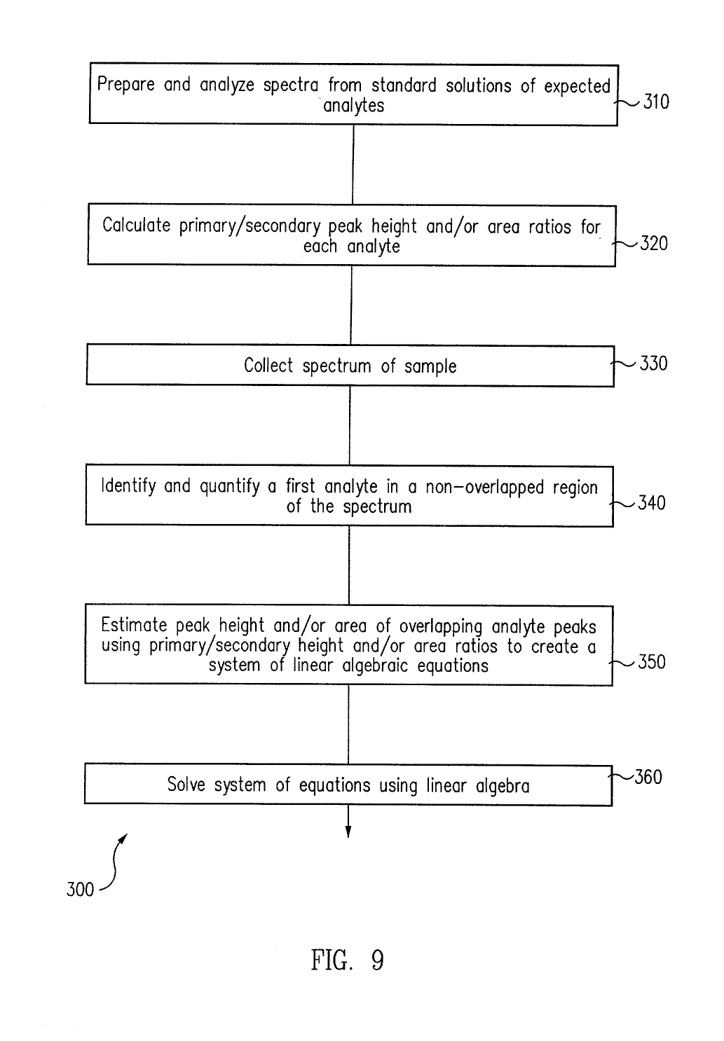

In a preferred embodiment of the present invention, a method is provided for calculating concentrations of individual additives and other analytes in a plating bath solution based on a single Raman spectrum captured as described above in the previous embodiments. The method of this embodiment is outlined in the flow chart shown in FIG. 9. In general as shown in FIG. 9, the method 300 comprises preparing and analyzing spectra from standard solutions of expected analytes at step 310. Primary and secondary peak height and/or area ratios for each analyte is calculated at step 320. Next, the spectrum for the sample of interest is collected at step 330. At step 340, identifying and quantifying a first analyte in a non-overlapped region of the spectrum is performed. The peak height and/or area of overlapping analyte peaks is estimated using primary/secondary height and/or area rations to create a system of linear algebraic equations at step 350, and the system of equations is solved at step 360.

More specifically, the sample spectrum contains a plurality of peaks, some of which are attributable to Raman scattering by analytes of interest such as one or more plating bath additives. In general a spectrum of a solution containing multiple analytes has regions of the spectrum where peaks attributable to more than one analyte overlap. This embodiment of the present invention provides a method for deconvoluting a spectrum comprised of peaks from numerous analytes. Prior to analysis of a sample spectrum, standard spectra are prepared for each analyte expected to be found in the sample. A primary and one or more secondary peaks are identified for each standard. In general, the peak heights and/or areas of each of the primary and one or more secondary peaks vary linearly with the concentration of the analyte. As such, the ratios of the area and/or height of an individual secondary peak to the primary peak as well as to other secondary peaks in the spectrum of a single analyte are approximately constant and independent of the concentration of the analyte. This property is used in conjunction with standard spectra and peak ratios from the expected analytes to differentiate the concentrations of multiple overlapping analytes in a sample spectrum as follows. A region of the sample spectrum containing only a single primary or secondary peak from a first analyte is identified. The concentration of that analyte is determined based on a calibration curve like the one shown in FIG. 7 based on the area and/or height of that peak in the standard spectrum. If, for example, a secondary peak from the first analyte occurs in the same region of the sample spectrum as the primary peak of a second analyte, the total area and/or height observed on the sample spectrum in the wavelength region of the primary peak of the second analyte is reduced by the expected height and/or area under the first analyte's secondary peak based on the concentration of the first analyte known from the primary peak height and/or area of the first analyte, the calibration curve, and the known ratio of the height and/or area of the primary and secondary peaks of the first analyte. This process is repeated as necessary to quantify all of the analytes of interest in a sample spectrum. Overlapping of multiple peaks from multiple analytes in a single wavelength region of a sample spectrum requires construction of a matrix of linear algebraic equations. The resulting matrix can be readily solved to identify the concentrations of each of the analytes by one of skill in the art provided that at least one peak of one analyte occurs alone in a discrete region of the spectrum.

Bilinear projection methods, like PCA (Principal Components Analysis), PCR (Principal Components Regression), PLS (Partial Least Squares regression, or Projection to Latent Structures regression) extract systematic information from the combination of many measurement variables. They also offer great interpretation features, to visualize sample patterns and variable relationships in easily interpretable graphical pictures. The multivariate models can then be used for indirect measuring, data reduction, exploration, prediction or classification/identification. These methods are easy to use and handle most multivariate problems despite intercorrelations, noise, errors, missing data, or extreme data table dimensions. Sub-routines and algorithms such as those featured in the aforementioned commercially available software packages may also be used to streamline the data analysis process or for conversion of peak height or areas directly to additive concentrations.

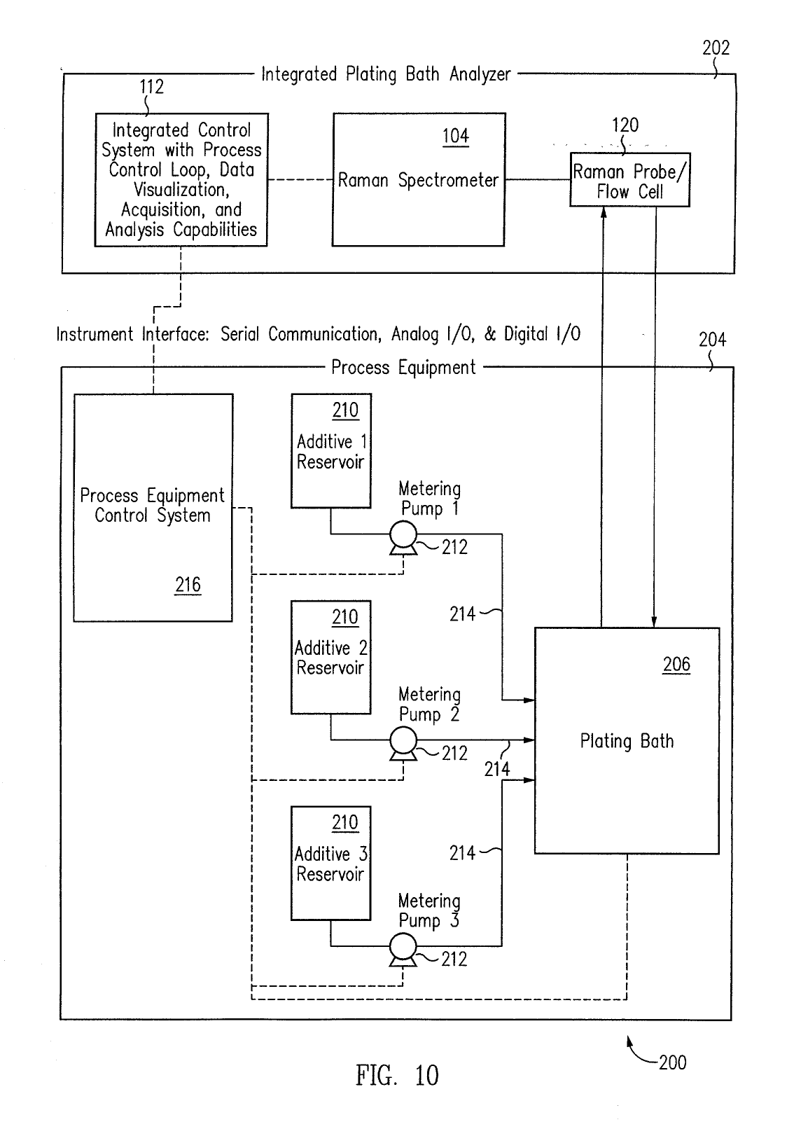

In a further embodiment of the present invention, the Raman analysis and bath additive concentration system and method are integrated with a commercially available chemical auto-dosing system to ensure that bath additive concentrations are maintained within an acceptable range during an ongoing, dynamic process. In this embodiment, shown schematically in FIG. 10, an integrated plating bath analyzer system 200 maintains the proper concentrations of additives in a plating bath by providing a feedback signal from a Raman spectroscopy system to an autodosing system to control the rates at which selected additives are added to the bath. In this embodiment, an analyzer subsystem 202 interfaces with a process subsystem 204 to provide chemical concentration data as well as control capability.

In general, a plating bath 206 is used to deposit a film on a wafer or some other substrate is maintained such that the concentrations of one or more plating additives in the bath do not vary from within optimal performance ranges. As the plating bath 206 is used in the deposition process, the composition of the bath changes. Byproducts are generated from the composition of the bath during the process as certain components are depleted. Maintaining the concentration level of key components, such as for instance additives in the bath, is essential in controlling the process. Also, certain byproducts can have adverse effects on the process. Typically, the bath and the additive metering hardware are a part of the process subsystem. However, it is not a requirement. The plating bath 206 is pumped to a wafer surface in a controlled manner and a filtration step is typically incorporated. Temperature, pH, and other parameters are controlled in the bath. The bath is constantly recirculated and filtered to ensure complete mixing and to remove contaminants such as for instance particles.

The analyzer subsystem 202 includes a spectrograph 104 including a fiber input and CCD array (not shown in FIG. 10) as described above. The spectrograph is preferably connected to a personal computer based control system 112 with control electronics for processing the signals received and quantified by the spectrograph and CCD array. The computer system 112 preferably consists of a computer, a CCD controller card that plugs into the computer mother board, communication PC cards such as a modem and an Ethernet card among others, and digital and analog input/output ports.

One or more additives supplied from one or more additive reservoirs 210 are metered into the bath 206 via metering pumps 212 to maintain the required concentration levels. In this embodiment, the concentrations of additives and byproducts are monitored via Raman spectroscopy as outlined in the preceding embodiments. These data are used to safe guard against processing with the bath in a non-optimal condition. Additives are supplied to the bath via supply lines 214 from the additive reservoirs at rates metered by the metering pumps 212 based on feedback received from the analyzer subsystem 202. In this closed-loop control scheme, the concentrations of key components of the bath are tightly controlled without dependence on empirical relationships or historical bath depletion data. As a component is added into the bath via any control and metering process, the concentration of that component is at its peak. This concentration gradually decreases over time during processing. The amplitude of the concentration variability can theoretically be minimized by supplying a continuous, uniform addition of additives to the bath 206. However, because real process conditions are never ideal or constant, constant corrections of the addition rate are necessary. Analyzer subsytem 202 provides continuous feedback to a process subsytem controller 216 that in turn controls the metering pumps 212 to adjust the delivery rate of the additives from the reservoirs 210 to the bath 206. The process subsystem controller 216 has built in algorithms and hardware inputs and outputs to directly control the additive metering pumps 212.

The system and method provided by this embodiment is capable of directly controlling the metering pumps 212 or transmitting data on the concentrations of additives and byproducts. Table 1 lists several interface capabilities and methods of the analyzer subsystem that may be included to accommodate varying requirements of different process equipment and systems into which this system and method may be integrated.

TABLE 1
Interface capabilities of an exemplary analyzer
subsystem

| Item | Signal Type | Purpose and Description |
|---|---|---|
| 1 | Digital Input/Output (24VDC | For controlling the metering the |
| | typical) | metering pumps directly |
| | | For process alarm and |
| | | permissive (go or no go for the |
| | | process equipment). |
| 2 | Relay/Dry Contact (varying | For hardware safety interlock |
| | voltage level) | circuit if required in addition to |
| | | item 1 functionalities. |
| 3 | Analog Input/Output (4 to 20 | For transmitting concentration |
| | mA or 0 to 5 VDC typical) | levels by scaling the signal from |
| | | 0 to 5 VDC to be 0 g/L to 50 |
| | | g/L for example |
| | | For controlling metering pump |
| | | rate |
| 4 | Serial Communication (RS232, | For communicating |
| | Universal Serial Bus, Ethernet, | concentration levels and other |
| | and others typical of Personal | set up parameters. By varying |
| | Computers) | communication drivers, wide |
| | | range of protocols can be |
| | | supported. Typical protocols |
| | | include custom ASCII, SECS, |
| | | TCP/IP, etc. |

The aforementioned embodiments of the system and method of the present invention are directed to analysis of plating bath additives in electrolytic plating systems. In an alternative embodiment, the system and method of the present invention are applied to analysis of additives in electroless plating baths. In comparison to other copper deposition techniques, electroless copper deposition is attractive due to the low processing cost and high quality of copper deposited. Additionally, barrier layers can be conveniently deposited using the same system and apparatus as is used for depositing copper seed and fill layers. The equipment for performing electroless metal deposition is relatively less expensive, as compared to other semiconductor equipment for depositing metals, and the technique allows for batch processing of wafers. Thus, overall cost can be reduced by using electroless deposition. In addition, electroless deposition of copper (as well as other metals) offers an advantage in the selective growth of the metal in an interconnect opening (such as a via opening). Selective growth eliminates the need for a polishing or etching step to remove the excess deposited material or reduces the amount of material removal if such a step is required. As noted previously, representative electroless plating systems and methods are disclosed in U.S. Pat. No. 5,695,810 and in Lopatin et al (in Characterization of Cu, Co, Ni and Their Alloys for ULSI Metallization, Conference Proceedings ULSI XIII, Materials Research Society, 1998).

In order for copper to be electrolessly deposited onto a surface of a conductive material, such as a metal layer or a barrier layer, the surface of the conductive material must be susceptible to the autocatalytic growth of copper. The barrier layer is deposited first. If the surface is not susceptible to such growth, then the surface must be activated for electroless growth of copper. Without such surface treatment, electroless growth of copper will not occur on a non-catalytic surface, when the wafer is subjected to the electroless copper deposition solution.

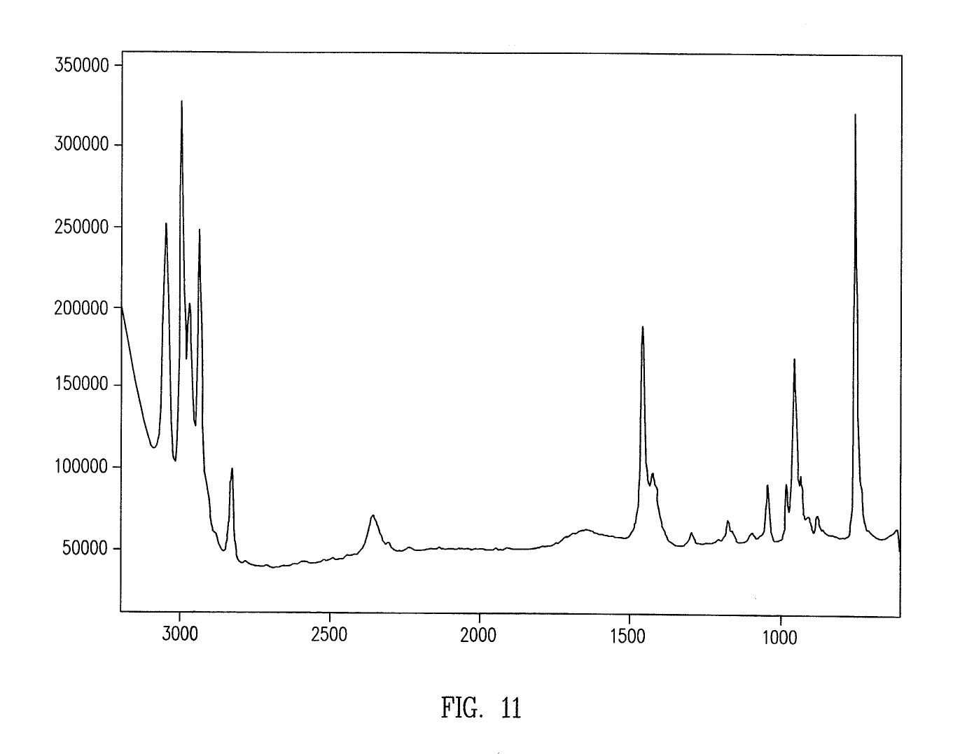

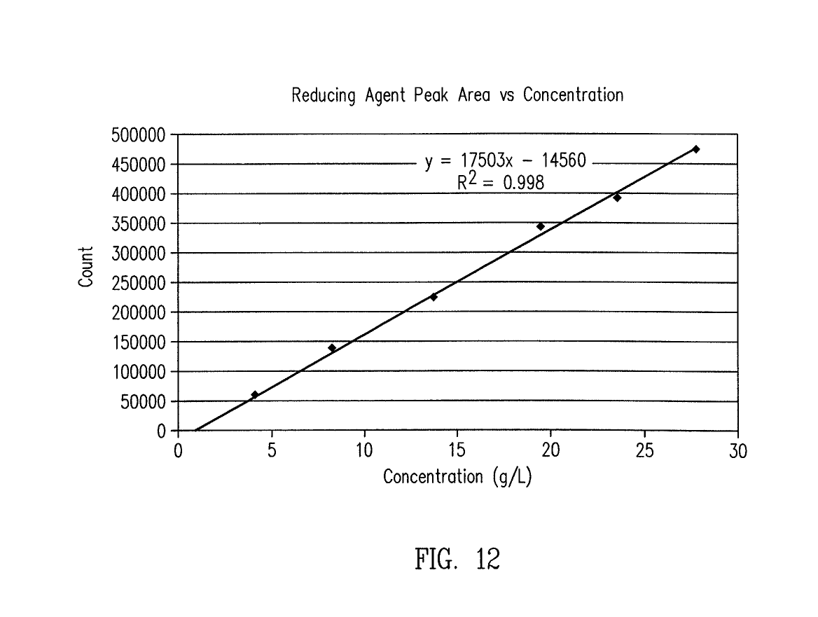

As disclosed in U.S. Pat. No. 5,695,810 and in Lopatin et al (in Characterization of Cu, Co, Ni and Their Alloys for ULSI Metallization, Conference Proceedings ULSI XIII, Materials Research Society, 1998 above), a representative electroless copper deposition solution is comprised of complexed cobalt, tungstate, and hypophosphite, among other constituents. A sample Raman spectrum of an electroless plating bath of this composition is shown in FIG. 11. Because of the different set of additives expected to be found in an electroless plating solution and the differing chemical and spectroscopic environment to be analyzed, it is preferable to apply the aforementioned system and method for analysis of an electrolytic plating solution to analysis of an electroless solution. A different wavelength of monochromatic light may produce a Raman spectrum of superior quality from an electroless solution. Identification of the preferred wavelength for analysis of an electroless plating bath is preferably achieved by careful consideration of the Raman behavior of the additives of interest and by examination of a UV-visible absorbance spectrum collected for the particular plating bath to be analyzed. Separate calibration curves are prepared for individual electroless plating bath additives as described above in the description of the exemplary embodiment of the electrolytic plating bath analysis method. These calibrations, such as the exemplary curve shown in FIG. 12, are preferentially used to identify and deconvolute overlapping peaks in the electroless bath.

### EXPERIMENTAL

A number of experiments were conducted according the method and system of the present invention. These experiments are intended for illustration purposes only, and are not intended to limit the scope of the present invention in any way.

### Example 1

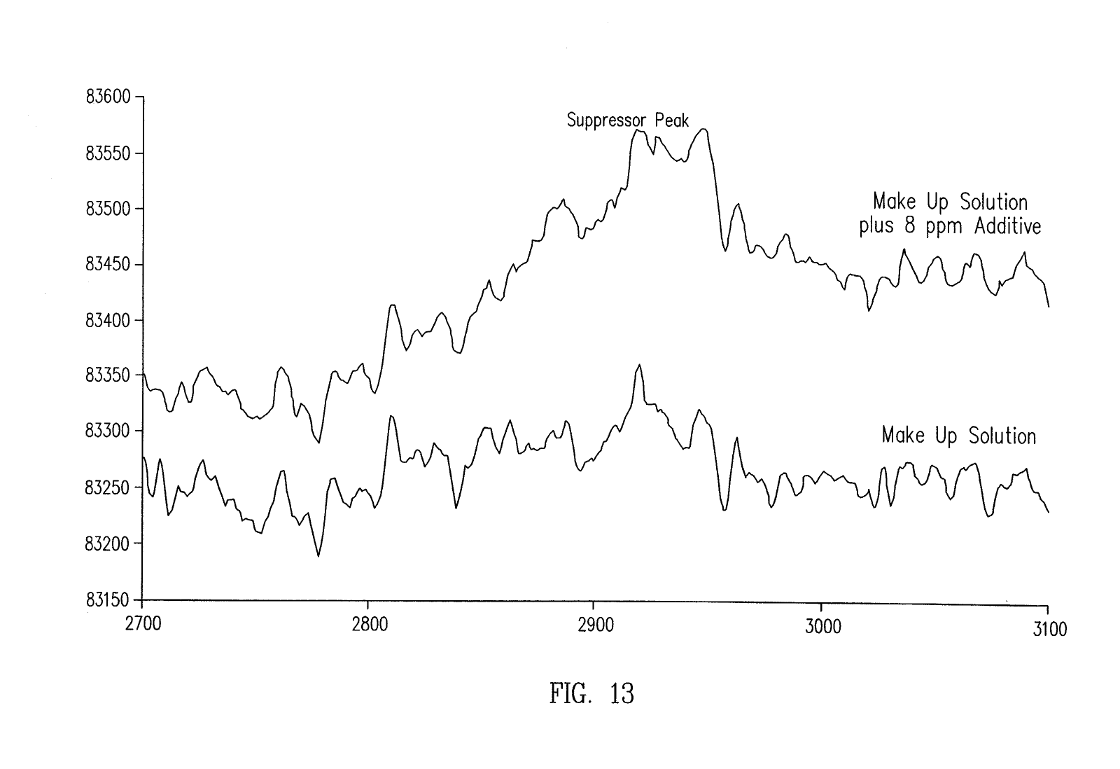

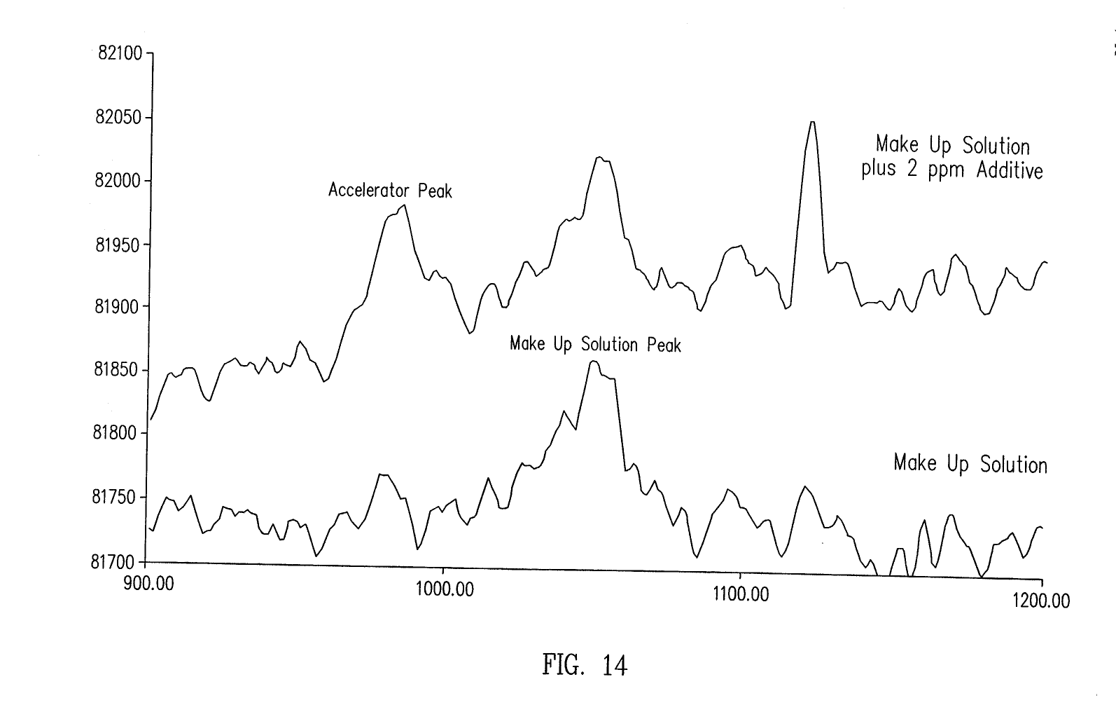

In one example, two plating solutions were tested; one containing only make up solution of copper sulfate, and the other containing the make up solution with 8 ppm of a suppressor additive. FIG. 13 shows the Raman spectra for each of the solutions. Of significant advantage, the additive is clearly detected within the make up solution. In another example, again two plating solutions were tested with the method and system of the present invention; one solution containing the copper sulfate make up solution, and the other containing the copper sulfate make up solution with 2 ppm of an accelerator additive. FIG. 14 shows the Raman spectra for each of the solutions, and again the additive is clearly detected within the make up solution.

### Example 2

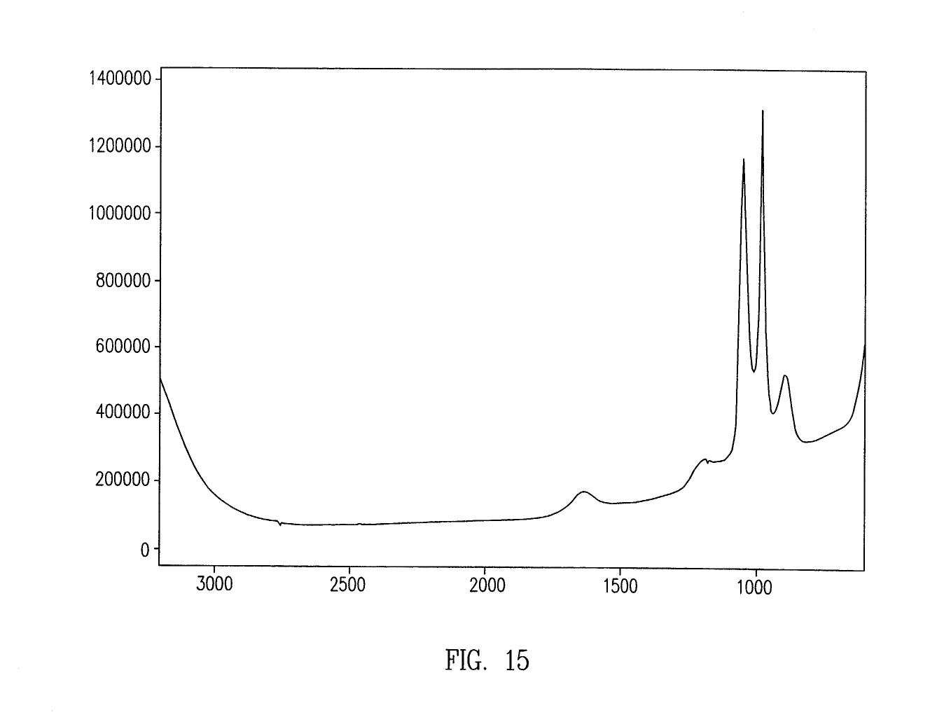

In another experimental example, an electrolytic copper plating bath solution was analyzed for suppressor and accelerator content. The commercially available bath composition was as follows: 60 g L⁻¹ copper sulfate, 120 mL L⁻¹ of 98% sulfuric acid, 8 mL of accelerator, and 6 mL of suppressor. The system used to analyze the plating bath is as described above and depicted schematically in FIG. 4. A 532 nm, 84 mW green Nd:YAG laser was used in conjunction with a fixed probe head as described above. The system integrates an internal laser calibration system based on an internal neon discharge. This enables greater measurement precision and a discrete non-varying laser output. The result is greater repeatability and more consistent peak areas. A thermoelectrically cooled CCD detector of the dimensions 1024×128 was used. The spectral resolution is 4 cm⁻¹. The bandwidth of analysis was 400 to 3000 cm⁻¹. A available personal computer running commercially available spectral analysis software packages (Unscrambler by CAMO Technologies and GRAMS/AI and PLSplus/IQ by Thermo Galactic) were used for data analysis and peak height and area determination. A 3 mL sample was withdrawn from the plating bath and a placed in a borosilicate glass vial. Acquisition times varied from approximately 1 to 10 minutes. A 5 minute acquisition period was used to obtain a spectrum as shown in FIG. 15. The peak height and peak area of alkyl groups for the suppressor and accelerator in the 2900 cm⁻¹ region of the spectrum were detected and analyzed. Accelerator sulfonic acid groups are difficult to differentiate from sulfuric acid Raman signals. Alternatively, carbon-sulfur and sulfur-sulfur bonds are analyzed for the accelerator in the approximate wavenumber range of 400 to 800 cm⁻¹. Based on comparison of the bath emission spectrum to known controls and a standard calibration curve, it was determined that the data thus obtained was consistent with the additive concentration as provided by the bath manufacturer.

### Example 3

In a further experimental example of the present invention, an electroless plating bath was analyzed using a 785 nm Raman system. The plating bath absorption maximum was 529 nm, so monochromatic light was provided at 785 nm. To compensate for the approximately fourfold reduction in sensitivity at this wavelength versus 532 nm as predicted by equation 2, the incident laser power was boosted to 150 mW. As noted above, Raman signal sensitivity is a linear function of power.

An electroless plating bath formulation containing complexed divalent cobalt, tungstate, and hypophosphite was analyzed using a quartz cell with a Renishaw Ramascope Raman System 1000 coupled to an Leica DMLM microscope. The system is equipped with diode laser excitation (785 nm., 150 mW of power), a entrance slit of 50 microns, an 1800 groves/mm high efficiency aluminized grating, and a high sensitivity thermoelectrically cooled CCD detector. The Raman spectra for reference areas were collected on adjacent clear field areas. Raman spectra are collected at 4 cm⁻¹ resolution from 200 to 3600 cm⁻¹, on liquid samples ranging from 300 microliter to 1 liter volumes. Under these conditions, an acquisition time of one minute was sufficient to generate spectral data for calibration and unknown analysis with less than 1% error.

The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

What is claimed is:

1. A Raman spectroscopy system for quantifying concentrations of one or more metal plating bath additives in a metal plating bath comprising:
a laser light source providing incident monochromatic light at a chosen wavelength, said wavelength being selected to fall within a region of low light absorbance on the ultraviolet-visible light absorbance spectrum for said bath;
a detector which quantifies the area under said peaks as a function of wavelength for detecting a bath emission spectrum of Raman scattered light from said bath;
a probe assembly comprising an immersible head and a probe window that is transparent to said chosen wavelength, said immersible head being immersed in a subvolume containing a sample of said bath such that said probe window is completely submerged to exclude ambient light for receiving Raman scattered light and transmitting to said detector; and
a spectrum processor configured to determine concentrations of each of said metal plating bath additives by deconvolution of said peaks in said bath emission spectrum of Raman scattered light based on one or more pre-calculated ratios of the areas under a plurality of peaks in a standard emission spectrum for each of said one or more metal plating bath additives.

2. The Raman spectroscopy system of claim 1 further comprising:
at least a first fiber optic cable for transmitting said incident monochromatic light from said source to said immersible head and therefrom through said probe window into said subvolume to produce said bath emission spectrum of Raman scattered light with peaks at one or more scattered wavelengths, and at least a second fiber optic cable for transmitting said Raman scattered light passing into said immersible head through said probe window to said detector.

3. The system of claim 1 wherein said detector further comprises:
a CCD receiver and a processor housed together and spaced apart from said laser source, said CCD receiver including a plurality of diode cells formed in a linear array, for receiving said Raman scattered light and wherein each of said diode cells exhibit output signals corresponding to the amount of received scattered light; and
said processor for receiving said output signals and generating a measurement signal corresponding to said output signals of said plurality of diode cells.

4. The Raman spectroscopy system of claim 1 wherein said immersible head is constructed of one or more acid-resistant materials.

5. The Raman spectroscopy system of claim 1 wherein said probe window is a lens and said lens adjusts the focal point of said incident monochromatic light directed from said immersible head into said subvolume such that the penetration depth of said incident monochromatic light into said subvolume of said bath is in the range of approximately 0.1 mm to 1 cm.

6. The Raman spectroscopy system of claim 1 further comprising one or more pumps, said pumps continuously circulating the plating bath through said subvolume so that said emission spectrum is representative of said bath as a whole.

7. The Raman spectroscopy system of claim 1 in which said source of incident monochromatic light is a diode laser.

8. The Raman spectroscopy system of claim 7 wherein said diode laser provides incident light at a wavelength in the range of approximately 340 to 550 nm.

9. The Raman spectroscopy system of claim 6 wherein said diode laser provides incident light at a wavelength of approximately 532 nm.

10. A method for quantifying concentrations of one or more metal plating bath additives in a metal plating bath comprising the steps of:
individually collecting a standard Raman emission spectrum in response to monochromatic light at a chosen wavelength for each of said one or more metal plating bath additives, said wavelength being selected to fall within a region of low light absorbance on an ultraviolet-visible light absorbance spectrum collected for said solution;
identifying a ratio of peak areas between each of the resultant peaks in said one or more standard emission spectra;
providing incident monochromatic light at said chosen wavelength from a monochromatic light source to said metal plating bath containing one or more additives;
detecting said light emitted by Raman scattering in said bath on a light detector;
converting said detected emitted light into a bath emission spectrum; and
analyzing said bath emission spectrum to quantify the concentrations of said one or more metal plating bath additives by creating a series of coupled linear equations in which the concentrations of said one or more metal plating bath additives are unknowns and said peak area ratios are knowns and solving said set of linear equations using linear algebra.

11. The method of claim 10 further comprising the step of:
adjusting the focal point of said incident monochromatic light such that its penetration depth into said bath is in the range of approximately 0.1 mm to 1 cm.

12. A method for determining concentrations of a plurality of analytes from a spectrum collected for a sample containing said analytes comprising the steps of:
preparing and analyzing a standard spectrum for each of said analytes;
calculating a ratio of a primary peak metric to a secondary peak metric for each analyte based on said standard spectra;
collecting a sample spectrum of said sample;
identifying and quantifying a first of said plurality of analytes in a region of said sample spectrum;
estimating a peak metric attributable to each of one or more of said plurality of analytes with a peak in an overlapping region of said sample spectrum based on said primary/secondary peak metric ratios;
creating a system of coupled linear algebraic equations based on said estimated peak metrics; and
solving said system of coupled linear algebraic equations using linear algebraic techniques.

13. A chemical auto-dosing system for controlling the concentration of one or more plating bath additives in a metal plating bath comprising:
a Raman spectroscopy probe that interfaces with said plating bath;
one or more additive reservoirs each containing one of said one or more plating bath additives;
one or more metering pumps that control the flow of said plating bath additives from said reservoirs to said plating bath;
a Raman spectrometer coupled to said Raman probe for quantifying a Raman spectrum emitted from said plating bath and collected by said probe;
an analyzer subsystem controller that processes said Raman spectrum to determine real time concentrations of said plating bath additives in said plating bath; and
a processing subsystem controller that receives and processes concentration data from said analyzer subsystem controller to provide control outputs to said metering pumps.
